(19) United States
(12) Patent Application Publication
(10) Pub. No.: US 2002/0062913 A1
(43) Pub. Date: May 30, 2002

(54) Liner sticking in a floppy disk

(75) Inventor: Pao Kuo Fu, Tauryuan Hsien (TW)

Correspondence Address: MERCHANT & GOULD PC, P.O. BOX 2903, MINNEAPOLIS, MN, 55402-0903, US

(73) Assignee: Megamedia Corporation

(21) Appl. No.: 09/725,995

(22) Filed: Nov. 29, 2000

(51) Int. Cl. B29D 7/01

(52) U.S. Cl. 156/233

(57) ABSTRACT

This invention is about sticking method for disk liner with the character on its welding, which makes use of a welding head to heat the liner surface at 160-220 degree in temperature for continuous 0.6-1.2 seconds, and thus make closely lining-up welds on the below surface of the liner melted, and then quickly fasten the liner on the shell without any glue.

### BACKGROUND OF THE INVENTION

(1) Field of the Technology

This invention is about sticking method for disk liner, especially with the welding to make the liner stick to the shell through the welds on liner surface in an accurate and quick process and without any glue.

(2) Existing Technology

The disk in computer processing system is commonly used for information recording and reading. It makes the recording and reading more convenient through the magnetic tack on a disk installed inside of the shell. The currently used floppy disk can be divided into “high density” and “low density” types, the former with 100 megabytes of memory and the latter with only 1.44 megabytes. However, both have liners between the disk and the shell stuck on the inner side of the shell in order to protect the magnetic disk.

As the above paragraph, the liner (1) is stuck on the inner face of the shell (2) (shown in FIG. 1). A floppy disk is composed of two shells and the inserted disk (3), which makes the disk (3) sandwiched by the liners on the bottom and the top. The sticking accuracy between the liner and the shell is different with the memory. That is, in the high density floppy disk the liner has to snugly and firmly stick on the shell, while in the low density one it needs to stick on the shell through several scattered welds on the outer flange. The different sticking accuracy needs different levels of technology, for example it applies the gluing in the high density floppy disk (the procedure shown as FIG. 2 Flow Chart). Firstly, locate the shell and spread UV glue on its inner face, then install the liner on it and level, and finally shoot the liner with UV lights for three times (1.2 seconds/each time) or continuous 3.6 seconds or more (once only) to make glue solidified and to stick the liner on the shell. However, it has to apply the more expensive glue as the material and take higher manufacturing costs, because the glue has to be coated as in printing with the appropriate thickness and equal-distance spreading (shown as FIG. 1) to avoid its coming out and maintain the level and smooth surface. The special UV light shooting system required for UV glue solidifying in this process will need extra costs to build up. Moreover, that it still takes 3.6 seconds or more on the shooting process for each floppy disk has doubtlessly induced a big issue for the high-cost process.

### SUMMARY OF THE INVENTION

Accordingly, the inventor proposes the solution techniques and methods as follows.

We all know the pitfalls of expensive UV glue and light shooting system and longer process time in liner sticking process for the high density floppy disk. Accordingly, new process techniques are created focusing on cost reduction, process time shortening, and efficiency promotion. This invention can make smooth and firm fastening between the liner and the shell through closely scattered welds by the welding method, which thus becomes one the best techniques due to its cost reduction through neglecting the process of glue coating and light shooting. This invention can quickly stick the liner to the shell through the melted welds on the shell surface heated by a welding head. That the method is much quicker than the traditional one and simultaneously can save the overall process time becomes the other character of this invention. In addition, this invention can achieve the benefits on time saving and glue usage avoiding when neglecting the leveling in the tradition process. The below paragraph will describe the preferred embodiment of this invention.

### BRIEF DESCRIPTION OF THE DRAWINGS

FIG. 1 Three-dimensional configuration of a floppy disk

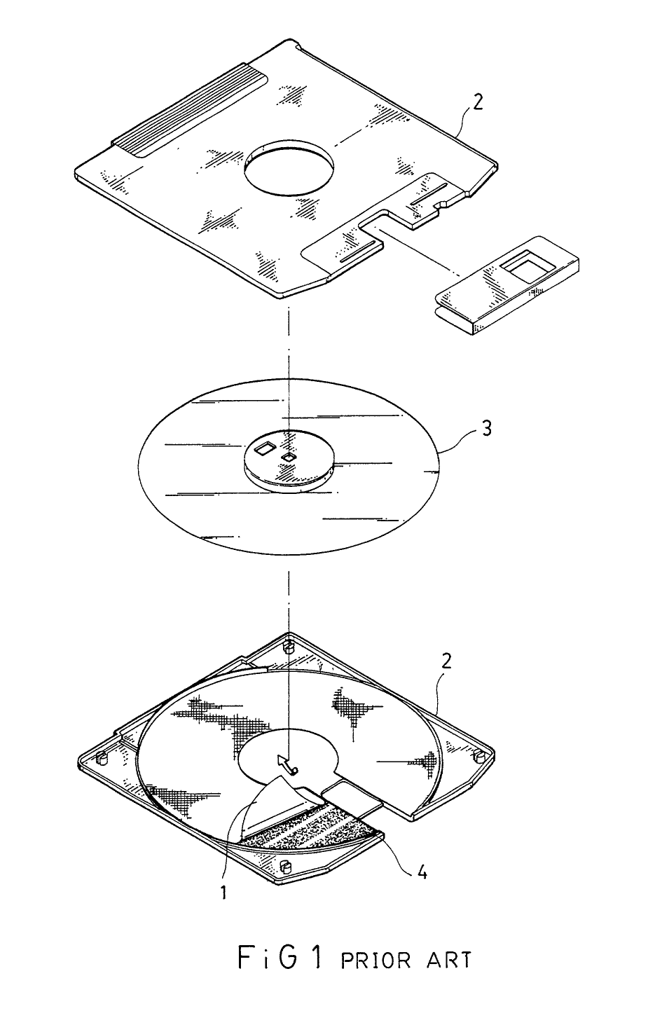

FIG. 2 Flow Chart for sticking between liner and shell in the traditional method

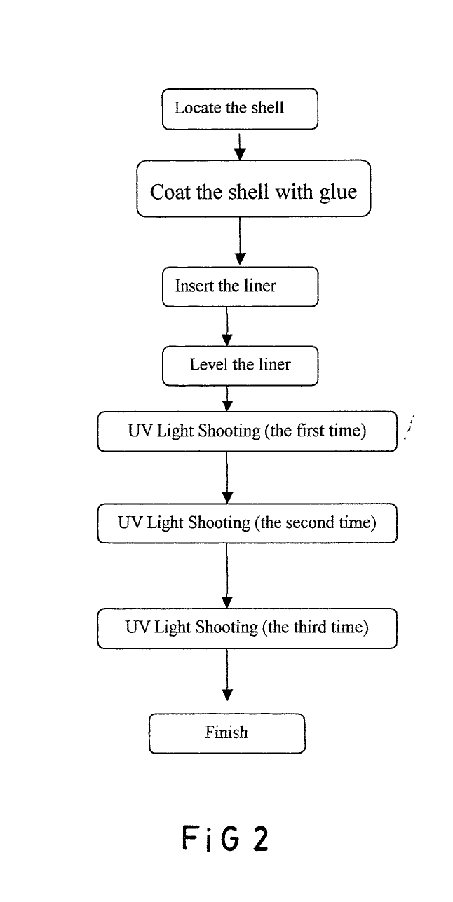

FIG. 3 Flow Chart for sticking between liner and shell in this invention

FIG. 4 Weld lining-up figure in this invention

FIG. 5A Sectional view for the liner and shell sticking structure in this invention

FIG. 5B Sectional view for the liner and shell sticking structure in the traditional

### DESCRIPTION OF THE PREFERRED EMBODIMENT

The invention disclosed herein is directed to the sticking method for disk liner. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

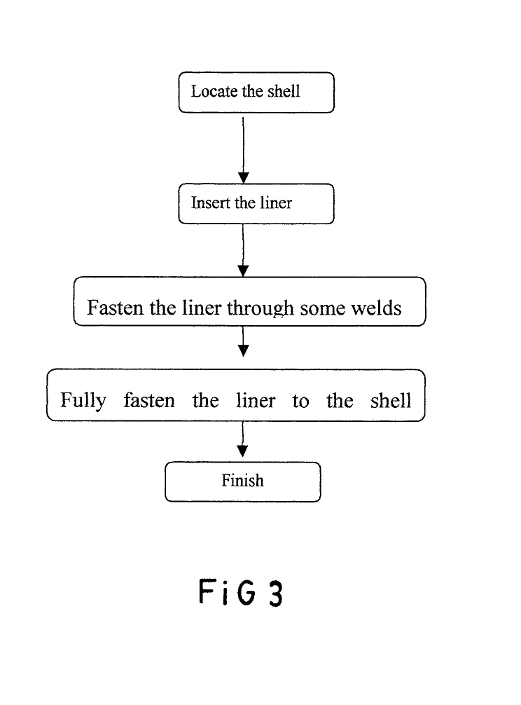

The flow chart on a better practice example of this invention refers to FIG. 3. The shell will be first located properly, and the liner will be installed on its surface. The liner is fastened on the shell through welding with at least 4 welds at the temperature of 120 degree C. for 0.5 second. When the fastened liner is moved under on a welding head with temperature of 160-220 degree C. and then is pressed down by the head for 0.6-1.2 seconds, the melting below the liner will make the liner and the shell stick together. The welds in the early stage can maintain the location stability between the liner and the shell in prior to moving to the next step.

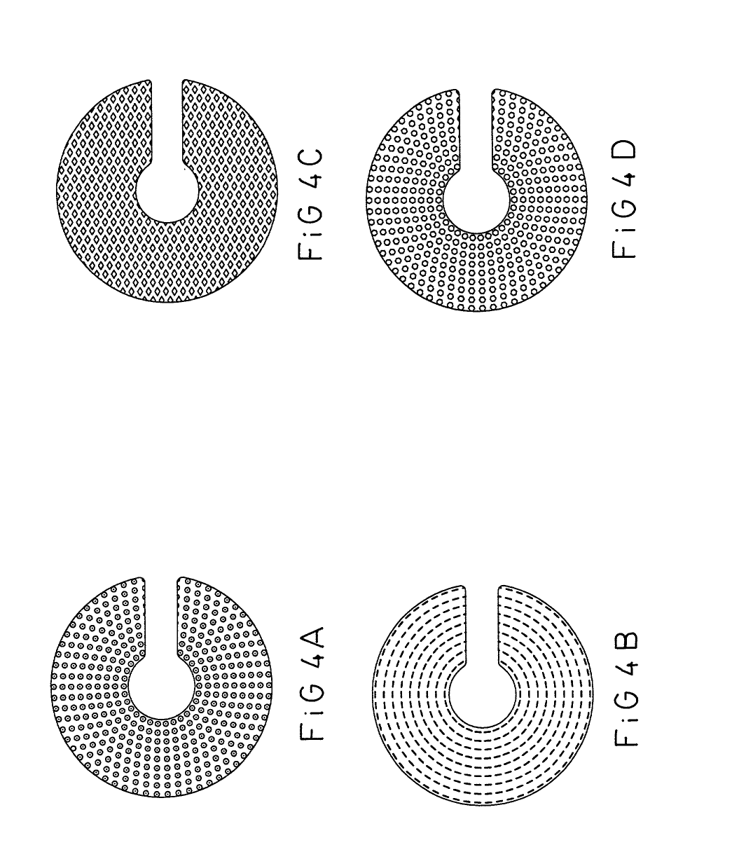

When sticking the liner to the shell, this invention applies closely lining up welds instead of the whole surface sticking in the tradition method. The shapes of the welds include cone, thin stripe, multi-edge, or cylinder shown as FIG. 4A-4G. The lining figurations include concentric (shown as FIGS. 4A, 4B, 4D, 4G), interlacing, radial (4E), and horizontal and vertical intercrossing (4F). Welds of the above shapes could be fastened with any above lining figurations on the shell surface.

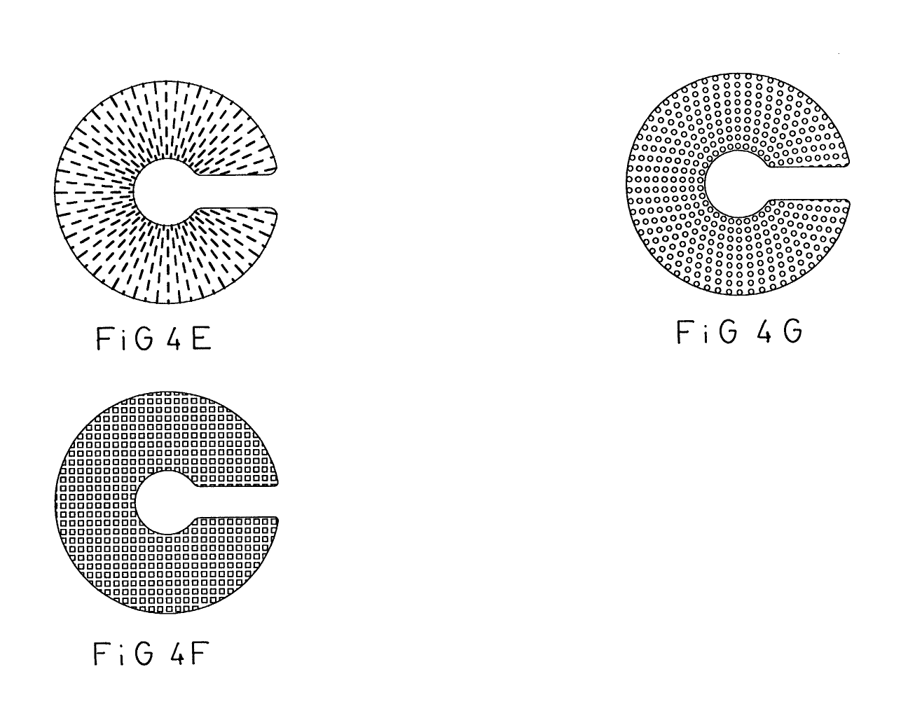

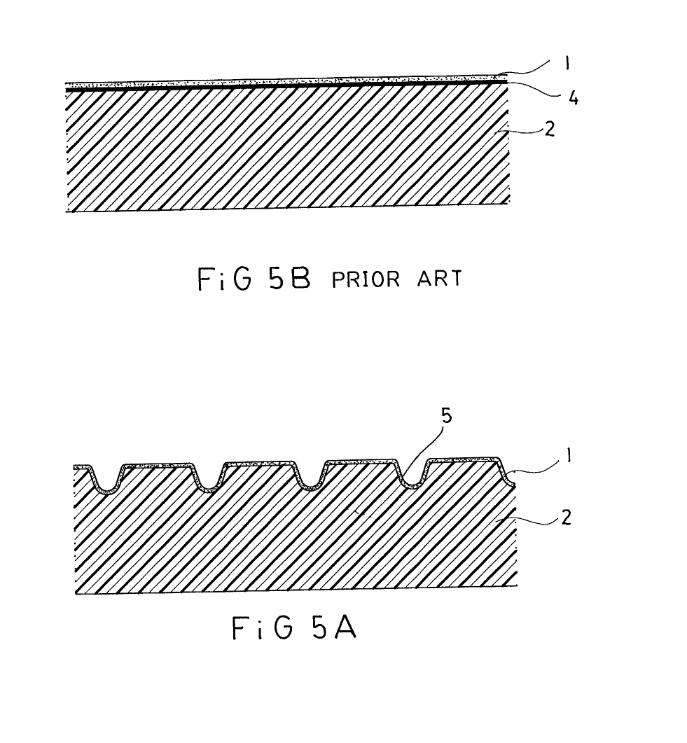

FIG. 5A is the section to show the liner sticking to the shell (2) surface in this invention. The liner (1) is melted and pressed down by the hot weld head, and the welds (5) thus form with depth of 0.15-0.25 mm. The sticking effects on welds (5) of the shell (2) by the hot weld head to make the liner and the shell stick together. The closely scattered welds is the major effect to make the whole liner (1) firmly stick to the shell. The structure lacks the gluing membrane (4) comparing to that in traditional method (shown as FIG. 5B), but won't influence the sticking effect between the liner and the shell.

The above procedure can save process on sticking the liner to the shell costs through the closely lining up welds and no use of any glue. The welding needs short time on the liner and the shell sticking process due to neglecting the glue coating and UV light shooting in traditional method, and thus shorten the process time for each floppy disk to improve the manufacturing efficiency. Most important of all, the sticking is as smooth and firm as that in the traditional method.

While the present invention has been particularly shown and described with reference to a preferred embodiment, it will be understood by those skilled in the art that various changes in form and detail may be without departing from the spirit and scope of the present invention.

I claim:

1. The liner sticking method.
Firstly, smoothly spread the liner on the surface of the shell. Then heat and press the liner with the welding head at temperature of 160-220 degree C. for continuous 0.6-1.2 seconds to form closely scattered and very deep welds. Finally, fly stick the liner to the inner surface of the shell through adhering those welds to the melting inner surface. Secondly, Under the application for the above item, the lining figurations include concentric, interlacing, radial, and horizontal and vertical intercrossing according to the liner's shape;
Under the application for either of the above two items, the shapes of the welds include cone, thin stripe, multi-edge, or cylinder;
Under the application for the first item, the welds are closely scattered on the liner according to its shape.
Under the application for either of the above two items, the depth of the weld is 0.15-0.25 mm.
Under the application for the first item, weld and fasten the liner to the shell through some of welds prior to welding all of the closely lining-up welds
